(19) United States
(12) Patent Application Publication
(10) Pub. No.: US 2009/0004339 A1
(43) Pub. Date: Jan. 1, 2009

(54) Method for producing coated shaped meat for preparation in a toaster, shaped meat product and its use for preparing a schnitzel in a toaster

(76) Inventor: Carsten Beermann, Warendorf (DE)

Correspondence Address: COLLARD & ROE, P.C., 1077 NORTHERN BOULEVARD, ROSLYN, NY, 11576, US

(21) Appl. No.: 12/215,558

(22) Filed: Jun. 27, 2008

(30) Foreign Application Priority Data
Jun. 28, 2007 (DE) 10 2007 030 104.0

(51) Int. Cl. A23L 1/31

(52) U.S. Cl. 426/92; 426/296

(57) ABSTRACT

A method for producing coated shaped meat for preparation in a conventional toaster forms from a molding material essentially slice-like shaped meat pieces having a mean thickness from 5 mm to 22 mm and a width or diameter from 50 mm to 160 mm. The shaped meat pieces are wet-coated with a wet-coating produced from crushed or minced meat-type raw materials, drinking water and auxiliary materials to cover essentially the whole surface-area of the respective shaped piece of meat. The respective wet-coated shaped piece of meat is dry-coated to cover essentially the whole surface-area of the respective wet-coated shaped piece of meat. The dry-coated shaped pieces of meat are deep-fried and surplus frying fat is removed so that the shaped meat pieces have a frying fat content of less than 15 percent by weight. The deep-fried shaped pieces of meat are then frozen.

The invention relates to a method for producing coated shaped meat for preparation in a conventional toaster, a frozen shaped meat product for preparation in a conventional toaster and in particular to the use of a frozen shaped meat product for preparing a schnitzel in a conventional toaster.

It is generally known to prepare frozen coated “ham schnitzel” for eating by heating them in an oven or a frying pan.

The present invention is based on the problem to find a method for producing coated shaped meat for preparation in conventional toasters and for respectively providing a shaped meat product suitable for preparation in a conventional toaster.

This problem is solved, on the one hand, by a method having the features as stated in claim 1. Furthermore this problem is solved by a frozen shaped meat product having the features as stated in claim 11.

The method according to the invention, essentially, comprises the following steps:

Forming essentially slice-like shaped pieces of meat from a moulding material containing pieces of meat, preferably pieces of ham, so that the respective shaped meat piece has a mean thickness in the range from 5 mm to 22 mm and a width or a diameter in the range between 50 mm and 160 mm,

Wet-coating the shaped pieces of meat with a wet-coating produced from crushed meat-type raw materials, drinking water and ancillary materials, so that the whole surface area or essentially the whole surface area of the respective shaped meat piece is covered with the wet-coating,

Dry-coating the wet-coated shaped pieces of meat so that the whole surface area of the respective wet-coated shaped meat piece is coated with a dry-coating,

Deep-frying the dry-coated shaped pieces of meat,

Separating surplus frying fat from the fried shaped meat pieces so that the frying fat content of the shaped meat pieces is less than 15 percent by weight, preferably less than 12 percent by weight, and

Freezing the fried shaped pieces of meat from which the surplus frying fat was removed.

The frying fat content of the shaped pieces of meat (shaped meat products) produced in this way is considerably reduced so that they can be prepared, ready for eating, in conventional toasters without problematic fat contamination of the toaster within a relatively short cooking time, preferably one toasting interval. The fried shaped pieces of meat are separated from the frying fat to such an extent that when the fried shaped pieces of meat are heated in a toaster, no or practically no frying fat is dripping into the toaster.

In this context conventional toasters are generally understood to be commercially available toasters which may comprise a conventional crumb tray, but are not equipped with any other special cleaning functions such as washable reflector plates which can be removed without tools.

In a preferred embodiment of the method according to the invention the surplus frying fat is separated from the fried shaped pieces of meat by blowing the fat off by means of an air current, which process is nozzle-controlled. This type of removal of the frying fat has proved to be very effective and reliable during tests.

In a further preferred embodiment of the method according to the invention provision is made for separating any surplus wet-coating from the wet-coated shaped pieces of meat prior to dry-coating and/or for separating any surplus dry-coating from the coated shaped pieces of meat prior to frying. This ensures that the coating of the ready-to-prepare shaped piece of meat is particularly thin and that the shaped piece of meat or the coating does not form any bubbles on the surface during the subsequent cooking process (frying). It is thereby ensured that the coated and fried shaped piece of meat is essentially of even diameter or thickness in all spots and that it is almost impossible to detach any parts of the coating from the fried shaped piece of meat.

The separated surplus wet-coating and/or dry-coating may be used for coating subsequent shaped pieces of meat thereby achieving a relatively small consumption of the wet-coating or dry-coating material during production of coated shaped pieces of meat.

The coating is preferably less than 25 percent by weight, in particular less than 20 percent by weight of the respective shaped piece of meat.

Also separating the surplus wet-coating and/or surplus dry-coating material is preferably performed according to an advantageous embodiment of the method according to the invention by using an air current to blow it off.

In order to produce shaped meat with good slice cohesion and good cuttability the invention further provides for crushing or mincing the pieces of meat and tumbling them prior to shaping them into shaped meat pieces. Furthermore it is envisaged to cool the pieces of meat during tumbling and then subject them to mechanical post-crushing or mechanical post-mincing. Cooling of the pieces of meat is preferably performed by means of CO₂-gas. The CO₂-gas has a smell and taste which is neutral. The post-crushed or post-minced meat pieces are then shaped to form shaped meat pieces which preferably, similarly to a toasted slice of bread, have the form of a rectangular or square slice.

Further preferred and advantageous embodiments of the method according to the invention are stated in the subclaims. It is to be understood that the disclosure of the present invention comprises all features stated in the attached claims, i.e. that the disclosure includes any combination of the features stated in the claims.

The invention will now be explained in detail with reference to the enclosed drawing by way of examples, in which

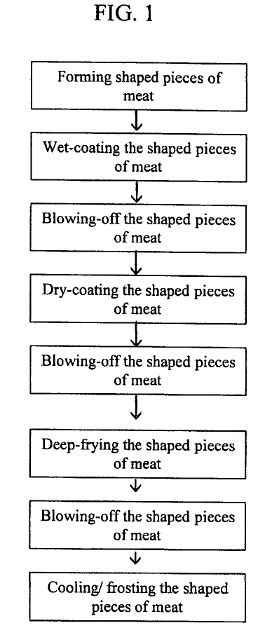

FIG. 1 shows various steps of the method according to the invention for producing a schnitzel or escalope made from shaped meat for preparing in a conventional toaster;

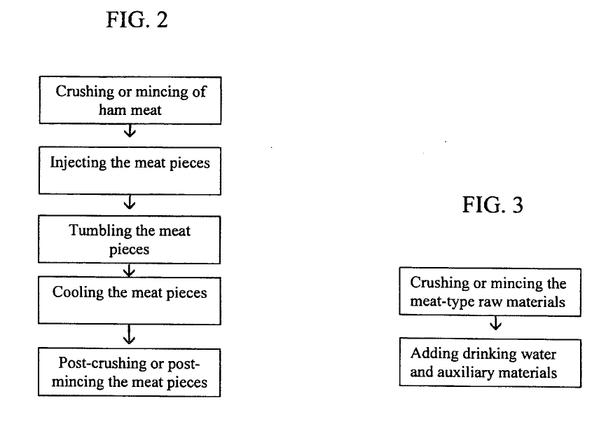

FIG. 2 shows various steps for producing a moulding mass or material consisting of pieces of meat for producing a schnitzel or escalope for preparing in a conventional toaster;

FIG. 3 shows various steps for producing a wet-coating for a schnitzel or escalope made from shaped meat for preparing in a conventional toaster;

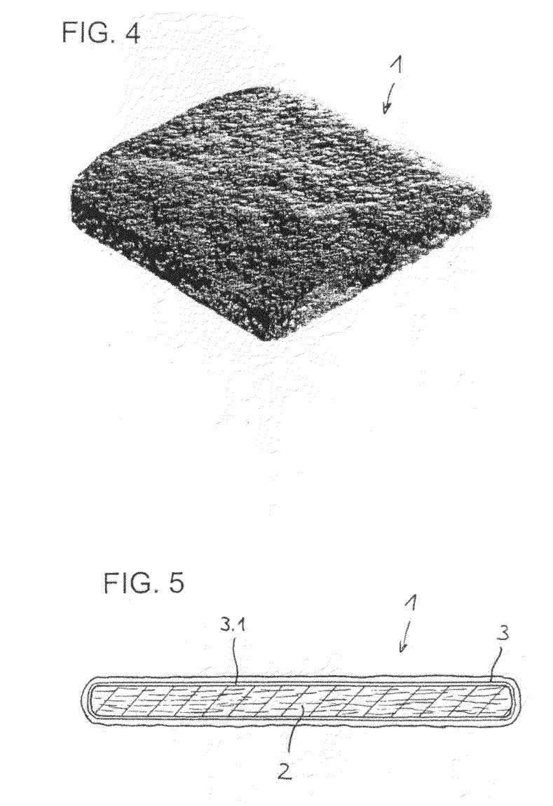

FIG. 4 shows a perspective view of a shaped meat product according to the invention for preparing in a conventional toaster;

FIG. 5 shows a sectional view of a schematically illustrated shaped meat product according to the invention;

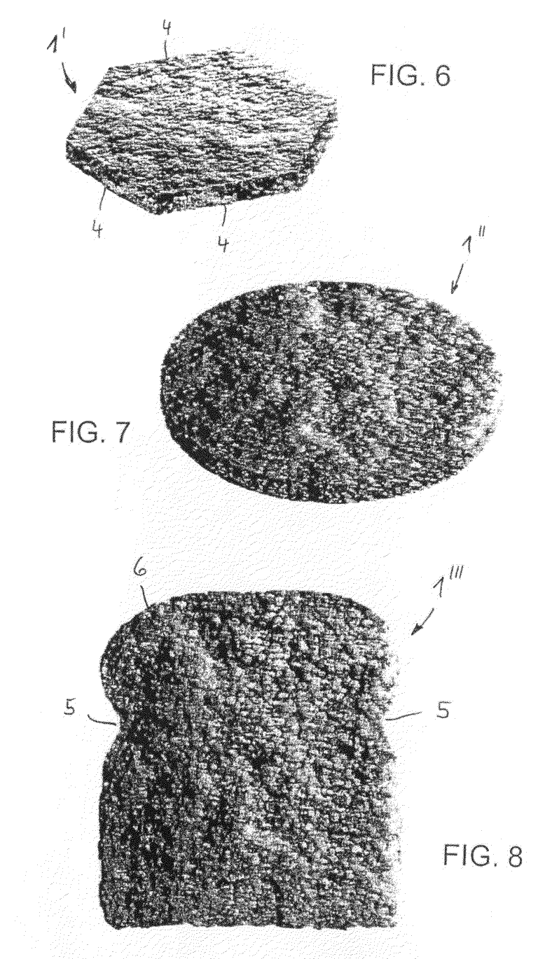

FIGS. 6 and 7 show perspective views of further examples of shaped meat products according to the invention having different shapes; and

FIG. 8 shows a top view of a further example of a shaped meat product according to the invention.

The shaped meat products according to the invention which could also be called toaster schnitzels may be produced as follows:

The first step is to produce a moulding material consisting of ham. To this effect suitable ham meat is crushed or minced. The sizes of the crushed or minced pieces of ham lie in the range from 2 mm to 12 mm, preferably in the range from 4 mm to 12 mm. The crushed or minced pieces of ham are then processed in a so-called tumbler during which process spice components are added. The tumbling causes an essentially homogenous meat material to be produced. The tumbling in particular has the effect of enhancing the water binding capability of the pieces of meat. Due to this process and the preferred measure of not using any spices in liquid form during production of the shaped meat product according to the invention, there will be no evidence of foreign water in the finished end product.

The crushed or minced pieces of meat are then cooled during tumbling or immediately thereafter. Preferably cooling is effected in the tumbler using N₂-gas, CO₂-gas or CO₂-snow to a temperature in the range between −1° C. and −5° C., for example −3° C.

Thereafter the crushed, tumbled and cooled pieces of meat are subjected to mechanical post-crushing or mechanical post-mincing. Post-crushing or post-mincing is preferably performed by means of a cutter. In this way a moulding material of jointed pieces of ham meat is obtained (see FIG. 2).

Next a wet-coating is produced using meat-type raw materials. To this end suitable meat-type raw materials are crushed or minced. The meat-type raw materials are crushed or minced to the extent where they are present in the wet-coating in a liquid consistency. The wet-coating is based on animal protein and is substantially free from starch. While the meat-type raw materials are being crushed and/or immediately thereafter, drinking water and auxiliary materials are added. The auxiliary materials for the production of the wet-coating are preferably cooking salt, lactate and/or phosphate (see FIG. 3).

From a moulding material containing ham meat pieces which may be produced according to the steps shown in FIG. 2, slice-like shaped pieces of meat are formed using a shaping tool. The slice-like shaped meat pieces are formed in such a way that the respective shaped meat piece has a mean thickness in the range from 5 mm to 22 mm and a width or a diameter in the range from 50 mm to 160 mm.

First the slice-like shaped meat pieces are coated using a wet-coating, which may be produced as described with reference to FIG. 3, and then dry-coated. During this process the whole surface area or essentially the whole surface area of the respective shaped piece of meat is covered in the wet-coating.

Prior to applying the dry-coating surplus wet-coating material is removed from the shaped pieces of meat.

Removing the surplus wet-coating material is preferably performed by blowing it off the wet-coated shaped pieces of meat. After removing the surplus wet-coating material, the respective shaped piece of meat is coated with dry-coating material based on wheat flour. Preferably the dry-coating also contains salt, yeast and/or other spices. The dry-coating is applied in such a way that the whole surface area of the respective wet-coated shaped piece of meat is covered in the dry-coating material.

After the shaped pieces of meat have been covered in dry-coating they are deep-fried. Prior to deep-frying the shaped pieces of meat are once more subjected to a blowing-off operation in order to remove surplus dry-coating material.

The deep-fried shaped pieces of meat are then fed to a blowing-off device, in which surplus frying fat is removed from the shaped pieces of meat by means of compressed air. To this end the blowing-off device is provided with several flat nozzles which carefully remove the surplus frying fat from the coating.

The blowing-off operation has the effect that the frying fat content of the ready-to-prepare toaster schnitzels is less than 15 percent by weight, preferably less than 12 percent by weight.

According to a specially preferred embodiment of the process according to the invention, provision is made for the meat pieces for the moulding material to be selected in such a way and for the wet-coating and/or the dry-coating to be prepared in such a way that the fat content of the deep-fried shaped pieces of meat from which the surplus frying fat was removed, is less than 11 percent by weight.

Finally the deep-fried shaped pieces of meat from which the surplus frying fat was removed are either frozen or frosted and packaged.

FIG. 5 shows a sectional view of a shaped meat product 1 according to the invention. 2 is the reference number for the shaped piece of meat made from pieces of ham meat, which is in a rectangular, square or polygonal slice-like form having a mean thickness in the range from 8 mm to 22 mm and a width or a diameter in the range from 50 mm to 160 mm. The whole surface area of the shaped piece of meat 2 is enclosed by a multi-layer coating 3. The first layer 3.1 applied directly to the shaped piece of meat is formed of a wet-coating produced from crushed or minced meat-type raw materials, drinking water and auxiliary materials. Onto this first layer is applied a second layer 3.2 in the form of a dry-coating, which, as already mentioned, is based on wheat flour and may additionally contain salt, yeast and/or at least one spice. The wet-coating does not contain any aromatic materials, extracts or flavour enhancers. It contains neither starch nor flour components.

The layer thickness of the two-layer coating 3 lies in the range from 2 mm to 6 mm.

Since the meat-type raw materials for the wet-coating 3.1 are crushed or minced to the extent where they are present in the wet-coating in a liquid consistency and since the wet-coating is substantially free from starch, the deep-fried, ready-to-use shaped meat product 1 ends up with a coating 3 of an especially even layer thickness which reliably adheres to the shaped meat product and is free from bubbles or essentially free from bubbles. This has the effect of ensuring that when the shaped meat product 1 according to the invention is prepared in a conventional toaster, there will essentially not be any separating or flaking of the coating 3 from the shaped meat product 2, or expressed in other words, any critical bubbles are prevented from forming between the coating 3 and the shaped meat product 2.

The shaped meat products 1 according to the invention contain neither any artificial preservatives nor any colour pigments or artificial flavour enhancers.

The ready-to-use shaped pieces of meat 2 are golden-brown in colour due to the coating 3. As mentioned above, the ham meat material is used to form essentially rectangular slice-like shaped pieces of meat for preparing in a conventional toaster. The sizes of the coated shaped meat products according to the invention may be, for example, approx. 8×8 cm, 9×9 cm, 10×10 cm, 11×11 cm or 9×11.5 cm. Preferably the corners of the slice-like shaped meat products are slightly rounded, whereby two adjacent corners are more rounded than the other two corners. The shaped meat product 1 according to the invention shown in FIG. 4 essentially exhibits the form of a classical slice of toasted bread. Its mean thickness is in the range from approx. 10 mm to 22 mm.

FIGS. 6 to 8 show further preferred shapes of the shaped meat product according to the invention. The coated, well-cooked shaped meat product 1′ of FIG. 6 is shaped polygonally; it has six corners, whereby the substantially evenly long narrow faces 4 which define the respective corners enclose an angle of approx. 120° and 240° resp. The mean thickness of the coated shaped meat product 1′ lies in the range from approx. 10 mm and 22 mm. The distance between the essentially parallel narrow faces 4 lies in the range from approx. 50 mm to 120 mm.

Instead of a hexagonal shape shown in FIG. 6 the shaped meat product according to the invention may also be of octagonal shape or round shape.

The coated, well-cooked shaped meat product 1″ shown in FIG. 7 is essentially of circular shape; its diameter is in the range from 50 mm to 160 mm and preferably in the range from 100 mm to 120 mm.

The coated, well-cooked shaped meat product 1′″ shown in FIG. 8 essentially has the shape of a classical slice of rusk. It has thus two indentations 5 opposite each other and a bow-shaped rounded head portion 6. Its width or height lies in the range from 90 mm to 160 mm; and its mean thickness lies also between approx. 10 mm and 22 mm.

In order to prepare it the shaped meat product (schnitzel) according to the present invention is inserted or pushed, still frozen, into a conventional toaster and heated at maximum heat output of the toaster. It is done in approx. 2×3 minutes. Another possibility for preparing shaped meat products according to the present invention is to use a conventional swing-open sandwich toaster instead of a conventional toaster.

1. A method for producing coated shaped meat for preparation in a conventional toaster, comprising the following steps:
Forming essentially slice-like shaped pieces of meat (2) from a moulding material containing pieces of meat, preferably pieces of ham, so that the respective shaped meat piece (2) has a mean thickness in the range from 5 mm to 22 mm and a width or a diameter in the range from 50 mm to 160 mm,
Wet-coating the shaped pieces of meat (2) with a wet coating (3.1) produced from crushed or minced meat-type raw materials, drinking water and auxiliary materials, so that the whole surface area or essentially the whole surface area of the respective shaped meat piece is covered with the wet-coating,
Dry-coating the wet-coated shaped pieces of meat, so that the whole surface area of the respective wet-coated shaped meat piece (2) is coated with a dry-coating (3.2),
Deep-frying the dry-coated shaped pieces of meat,
Separating surplus frying fat from the fried shaped meat pieces so that the frying fat content of the shaped meat pieces is less than 15 percent by weight, preferably less than 12 percent by weight, and
Freezing the fried shaped pieces of meat (2) from which surplus frying fat was removed.

2. A method according to claim 1, wherein prior to dry-coating surplus wet-coating material (3.1) is removed from the wet-coated shaped pieces of meat (2) by blowing it off using an air current.

3. A method according to claim 1, wherein prior to frying surplus dry-coating material (3.2) is removed from the dry-coated shaped pieces of meat by blowing it off using an air current.

4. A method according to claim 1, wherein the wet-coating (3.1) is produced using cooking salt, lactate and/or phosphate as auxiliary materials.

5. A method according to claim 1, wherein the meat pieces are tumbled prior to forming them into shaped pieces of meat (2)

6. A method according to claim 5, wherein the meat pieces are cooled during tumbling.

7. A method according to claim 5, wherein after tumbling and prior to forming them into shaped pieces of meat (2) the meat pieces are subjected to mechanical post-crushing or mechanical post-mincing.

8. A method according to claim 1, wherein the meat-type raw materials for the wet-coating (3.1) are crushed or minced to an extent, where they are present in the wet-coating in a liquid consistency.

9. A method according to claim 1, wherein the meat pieces for the moulding material are selected in such a way, and the wet-coating (3.1) and/or the dry-coating (3.2) are prepared in such a way that the deep-fried shaped pieces of meat (2) from which the surplus frying fat has been removed have a fat content of less than 11 percent by weight.

10. A method according to claim 1, wherein the wet-coating (3.1) is based on animal protein and is essentially free from starch.

11. A deep-frozen shaped meat product (1, 1′, 1″, 1′″) for preparing in a conventional toaster, comprising a coated and deep-fried shaped piece of meat (2) produced from pieces of ham meat, which is essentially in the form of a rectangular, square, round or polygonal slice having a mean thickness in the range from 8 mm to 22 mm and a width or a diameter in the range from 50 mm to 160 mm, which is coated with a coating (3) covering the whole surface area and formed of a wet-coating (3.1) produced from crushed or minced meat-type raw materials, drinking water and auxiliary materials and a subsequently applied dry-coating (3.2), and which has a frying-fat content of less than 15 percent by weight, preferably less than 12 percent by weight.

12. A deep-frozen shaped meat product according to claim 11, wherein the coating (3) is less than 25 percent by weight, preferably less than 20 percent by weight, of the shaped piece of meat.

13. A deep-frozen shaped meat product according to claim 11, wherein the wet-coating (3.1) is based on animal protein and is essentially free from starch.

14. A deep-frozen shaped meat product according to claim 11, wherein the coating (3) has a layer thickness in the range from 2 mm to 6 mm.

15. The use of a frozen shaped meat product (1, 1′, 1″, 1′″) consisting of a coated and deep-fried shaped piece of meat (2) produced from pieces of ham meat, which is essentially in the form of a rectangular, square, round or polygonal slice having a mean thickness in the range from 8 mm to 25 mm and a width or a diameter in the range from 50 mm to 160 mm, which is coated with a coating (3) covering the whole surface area and formed of a wet-coating (3.1) produced from crushed or minced meat-type raw materials, drinking water and auxiliary materials, and of a subsequently applied dry-coating (3.2), and which has a reduced frying fat content of less than 15 percent by weight, preferably less than 12 percent by weight, for preparation of a schnitzel in a conventional toaster.
